(19) United States
(12) Patent Application Publication
(10) Pub. No.: US 2025/0297623 A1
(43) Pub. Date: Sep. 25, 2025

(54) HYDRAULIC VALVE ASSEMBLY

(71) Applicant: HAWE Hydraulik SE, Aschheim (DE)

(72) Inventors: Thomas Wechsel, Aschheim (DE); Hermann Achatz, Aschheim (DE)

(73) Assignee: HAWE Hydraulik SE, Aschheim (DE)

(21) Appl. No.: 18/864,285

(22) PCT Filed: May 4, 2023
(86) PCT No.: PCT/EP2023/061852

§ 371 Date: Nov. 8, 2024

(30) Foreign Application Priority Data
May 11, 2022 (DE) 10 2022 204 632.3

(51) Int. Cl. F15B 13/044; F16K 27/00; F16K 37/00

(52) U.S. Cl. CPC F15B 13/044; F16K 27/003; F16K 37/0041

(57) ABSTRACT

The present invention relates to a hydraulic valve assembly (10) with a connection block (12) and at least one valve section (14.1 . . . 14.n), wherein the hydraulic valve assembly (10) comprises a main electronics holder (16) with a main electronics module (18) disposed therein, and wherein the valve section (14.1 . . . 14.n) comprises a valve section electronics holder (20.1 . . . 20.n) with a valve section electronics module (22.1 . . . 22.n) disposed therein

### CROSS REFERENCE TO RELATED APPLICATION

This application claims the priority benefit from PCT Application No. PCT/EP2023/061852 filed May 4, 2023, which claims the priority benefit from German Patent Application No. 10 2022 204 632.3, filed on May 11, 2022, the entire contents of which are incorporated herein by reference in their entirety.

### FIELD

The present disclosure relates to a hydraulic valve assembly. In particular, the present disclosure relates to a hydraulic valve assembly comprising a connection block and at least one valve section hydraulically connected to the connection block.

### BACKGROUND

Such hydraulic valve assemblies are known from the state of the art, for example from EP 2 063 159 A1. There, several valve sections are installed in series like a sandwich and these are controlled via a common bus system, in that each valve section has valve electronics integrated in its housing. The valve electronics can communicate with a higher-level control unit that is not part of the valve assembly via the bus system. For this purpose, a contact pin is inserted into the cable of the bus system via a cover in order to generate a signal connection.

Such hydraulic valve assemblies are used to control hydraulic consumers in mobile hydraulic applications. Examples include agricultural and forestry machinery, such as tractors or harvesters. Among other things, supports, a mast or mobile hydraulic systems connected to the machine, such as front loaders, balers, loader wagons, earth drills or cable winches, are then controlled.

It is the objective of the present disclosure to provide a hydraulic valve assembly with onboard electronics which is considerably more practicable, whose availability is increased and which is more favorably constructed.

### SUMMARY

In one embodiment, a hydraulic valve assembly includes a connection block and at least one valve section hydraulically connected to the connection block. The hydraulic valve assembly may include a main electronics holder with a main electronics module disposed therein. The valve section may include a valve section electronics holder with a valve section electronics module disposed therein.

In one embodiment, the connection block includes the main electronics holder in the form of a connection block electronics holder, and the main electronics module is a connection block electronics module.

In one embodiment, the main electronics module is detachably disposed in the main electronics holder. The valve section electronics module may be detachably disposed in the valve section electronics holder.

The main electronics module and the valve section electronics module may be different. In one embodiment, the main electronics module may include a main control unit and the valve section electronics module may include a secondary control unit.

In one embodiment, the hydraulic valve assembly includes an electrical backbone. The main electronics module and the valve section electronics module are connected to one another via the electrical backbone.

The main electronics module may include a backbone communication unit.

In one embodiment, the main electronics module includes an external communication unit for connection to a bus system and the external communication unit may include an interface for wireless communication or data transmission.

In one embodiment, the valve section electronics module includes a movement control unit.

In one embodiment, the main electronics module includes a voltage connection and a voltage regulator. A supply voltage can be applied to the valve section electronics module via the electrical backbone.

In one embodiment, the valve section may include a movable hydraulic closing member, and the valve section electronics module may include a position sensor for monitoring the position of the closing member.

In one embodiment, the valve section may include at least one working connection for connecting a hydraulic consumer, and a signal-controlled movement of the closing member relieves the working connection. A signal via the bus system initiates the signal-controlled movement.

In one embodiment, the valve section electronics module includes a sensor module.

In one embodiment, the valve section is a first valve section and the valve section electronics module is a first valve section electronics module. The hydraulic valve assembly includes at least one second valve section with a second valve section electronics module. The connection block is hydraulically connected to the first valve section and the second valve section. The main electronics module is connected to the first valve section electronics module via the electrical backbone. The second valve section electronics module has a feed-through for the electronic backbone. The second valve section electronics module is connected to the first valve section electronics module.

In one embodiment, the first valve section electronics module includes a secondary control unit and wherein the second valve section electronics module does not have a secondary control unit.

In another embodiment, the first valve section includes at least one first actuating unit and the second valve section includes at least one second actuating unit. The first actuating unit and the second actuating unit are connected to a movement control unit of the first valve section electronics module. The first actuating unit is preferably a first solenoid or a first electromechanical drive. The second actuating unit is preferably a second solenoid or a second electromechanical drive.

In another embodiment, the first valve section electronics module may include a backbone communication unit.

In another embodiment, the second valve section includes a movable hydraulic closing member, in particular a spool piston. The second valve section electronics module includes a second position sensor for monitoring the position of the closing member. The second position sensor is connected to the secondary control unit of the first valve section electronic module.

### BRIEF DESCRIPTION

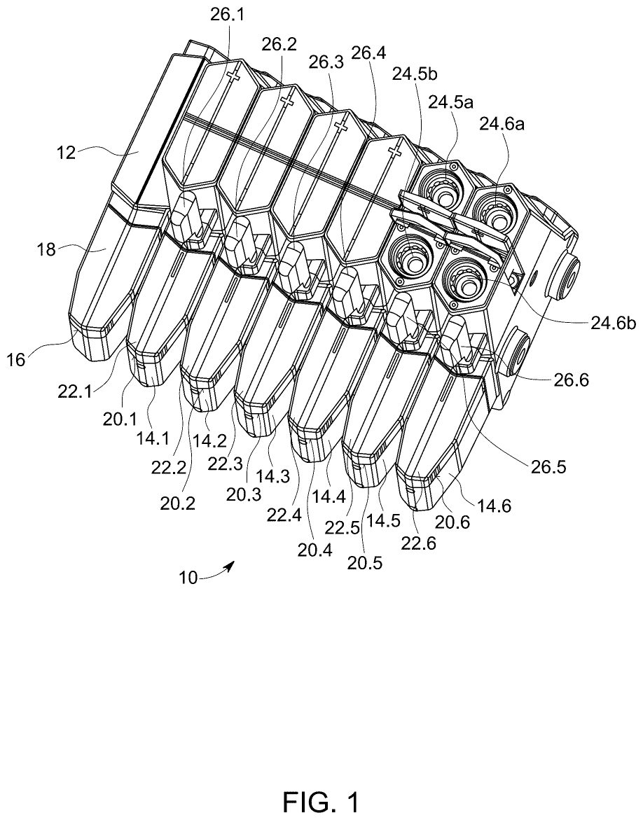

FIG. 1 depicts a first perspective view of a hydraulic valve assembly according to the present disclosure;

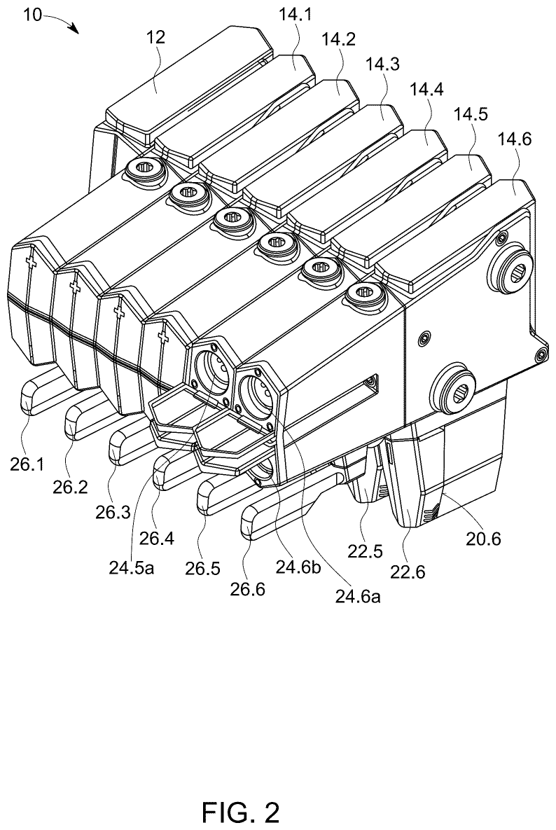

FIG. 2 depicts a second perspective view of the hydraulic valve assembly according to the present disclosure;

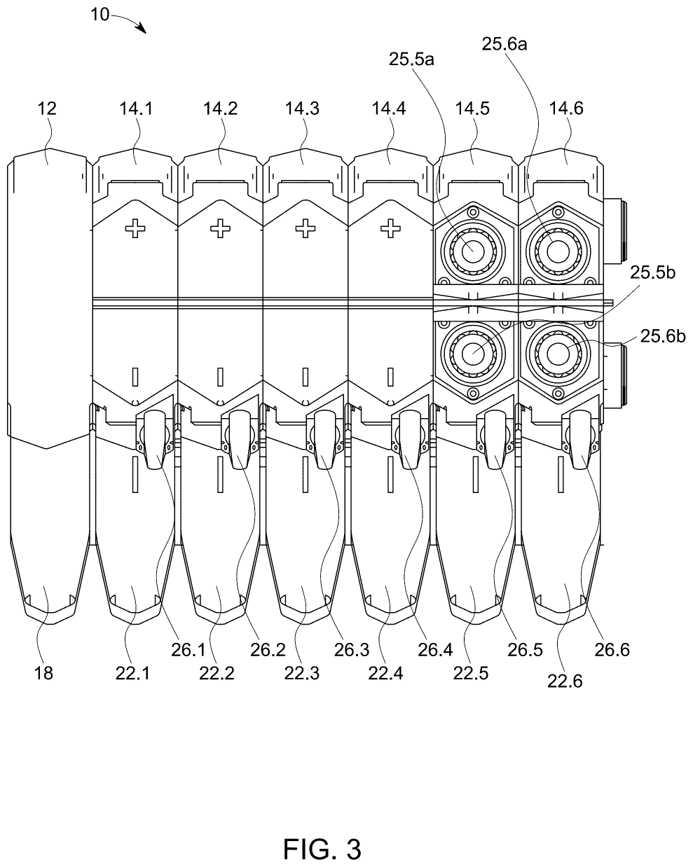

FIG. 3 depicts a top view of the hydraulic valve assembly according to the present disclosure;

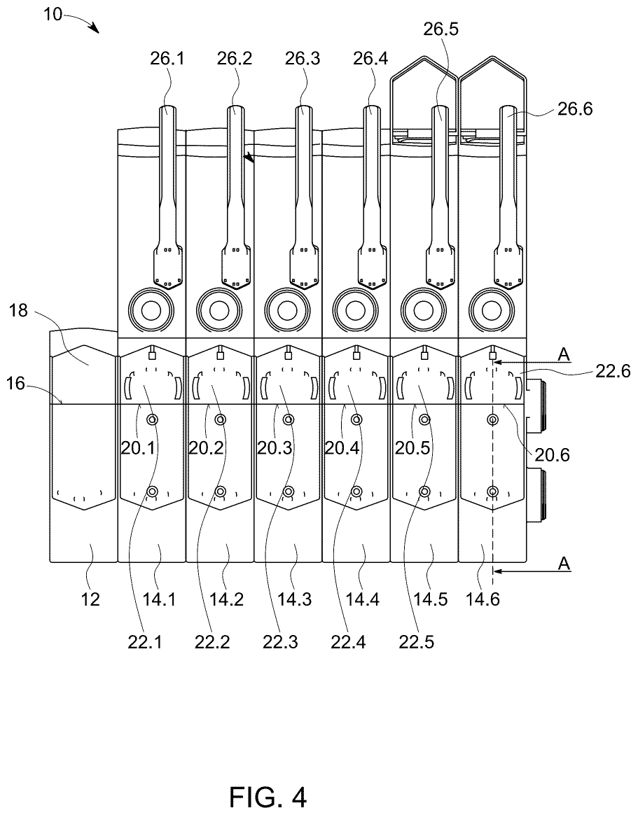

FIG. 4 depicts a first side view of the hydraulic valve assembly according to the present disclosure;

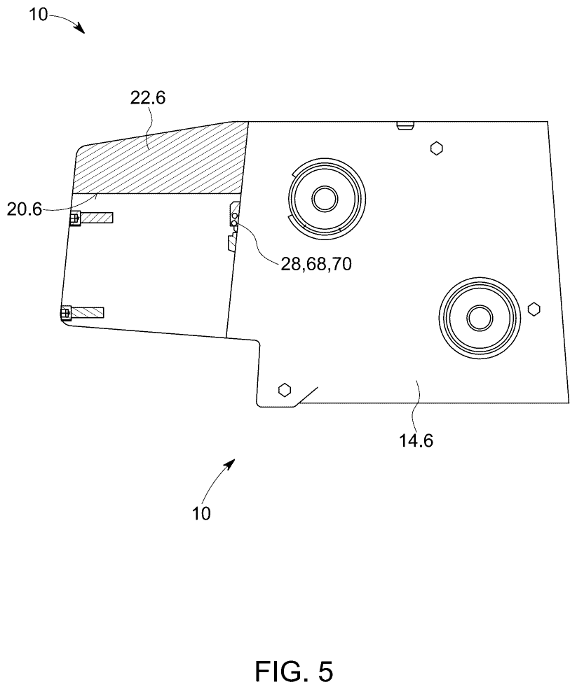

FIG. 5 depicts a cross-section along the line A-A shown in FIG. 4;

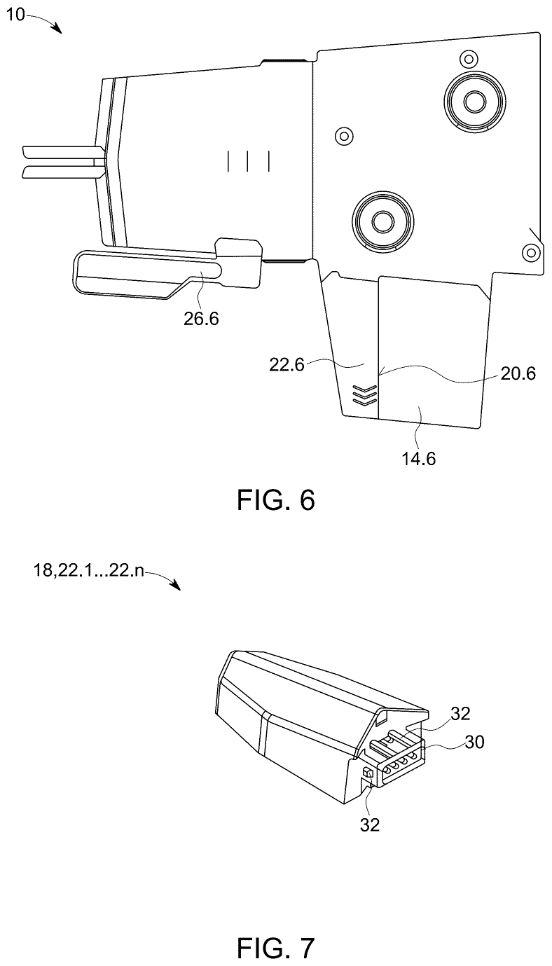

FIG. 6 depicts a second side view of the hydraulic valve assembly according to the present disclosure;

FIG. 7 depicts a perspective view of a main electronics module or a valve section electronics module;

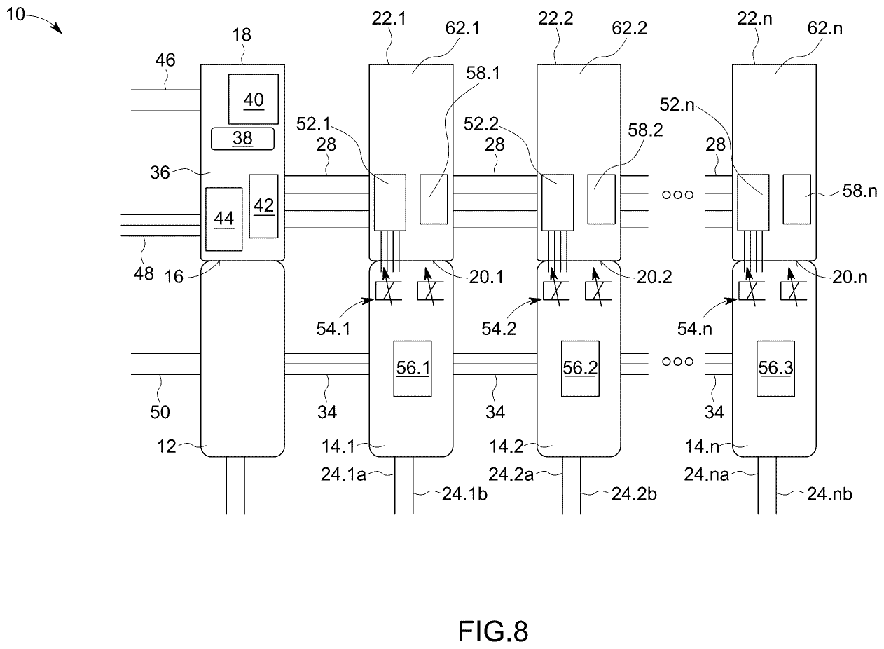

FIG. 8 depicts a schematic view of a first variant of the hydraulic valve assembly according to the present disclosure;

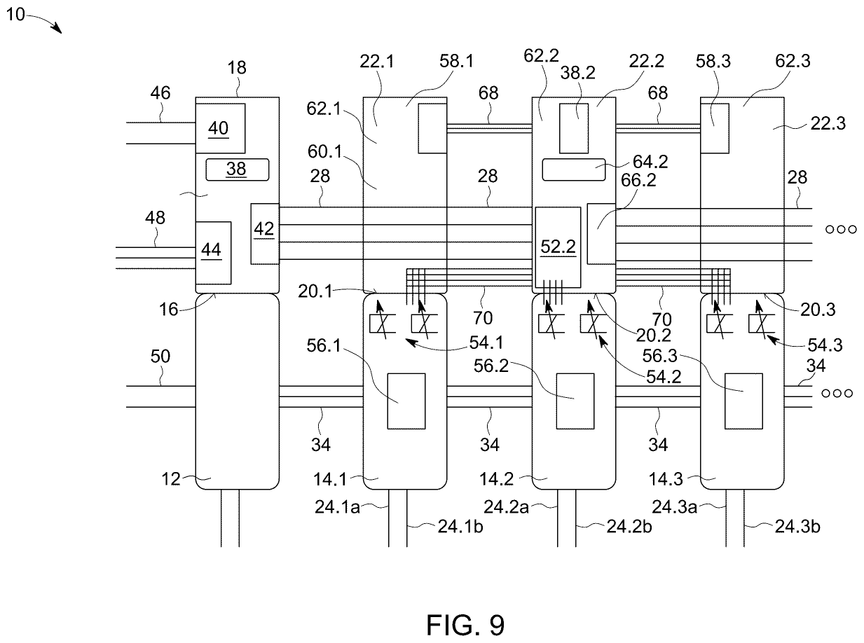

FIG. 9 depicts a schematic view of a second variant of the hydraulic valve assembly according to the present disclosure;

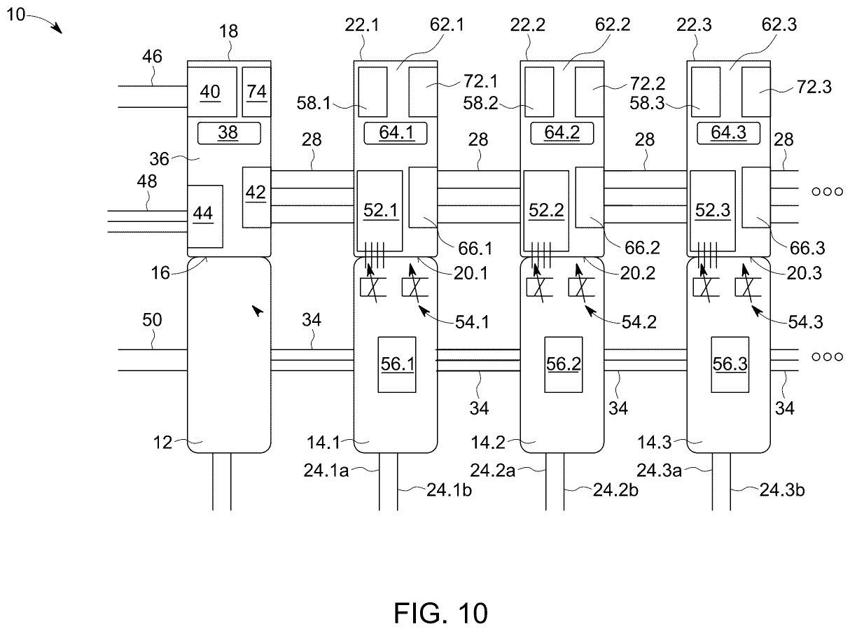

FIG. 10 depicts a schematic view of a third variant of the hydraulic valve assembly according to the present disclosure; and

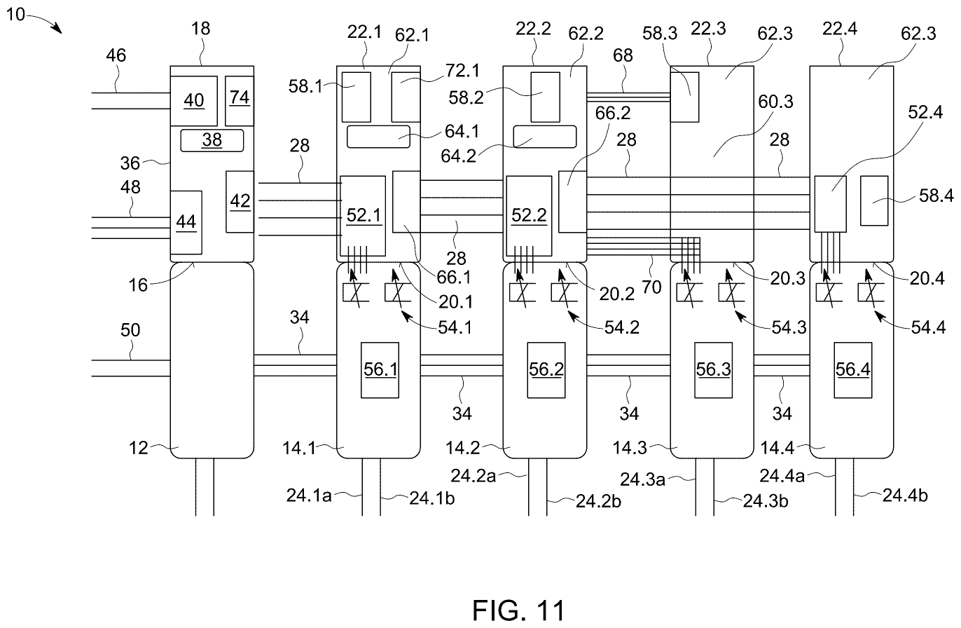

FIG. 11 depicts a schematic view of a fourth variant of the hydraulic valve assembly according to the present disclosure.

### DETAILED DESCRIPTION

One disadvantage of the known solution is that the valve electronics are located inside the housing of the valve section, meaning that maintenance or replacement is only possible with great effort. Furthermore, a new cable usually has to be used for replacement, which in turn is then penetrated by the contact pin during reassembly. The hydraulic circuit must also be opened for this, which in turn can lead to unwanted dirt ingress. In addition, the valve electronics are designed in such a way that all relevant functions for the entire valve control are provided in the electronics. This results in relatively expensive valve electronics per valve section.

In addition, the known hydraulic valve assemblies can only be used to a limited extent if a hydraulic section or the valve electronics fail.

The solution to the problem is achieved with a hydraulic valve assembly according to the embodiments are described in the present disclosure.

The hydraulic valve assembly according to the present disclosure comprises a connection block. A main electronics module is disposed in a main electronics holder of the hydraulic valve assembly. Furthermore, the hydraulic valve assembly according to the present disclosure comprises at least one valve section. The valve section is hydraulically connected to the connection block in a known manner so that, for example, hydraulic consumers connected to the valve section can be pressurized via the connection block and the valve section or, for example, can also be relieved to the tank. The valve section comprises a valve section electronics holder. A valve section electronics module is arranged in the valve section electronics holder.

This provides a simple hydraulic valve assembly. The main electronics module and the valve section electronics module are disposed in the respective holders and are therefore easily accessible and therefore interchangeable. This results in a cost-effective and simple design of the hydraulic valve assembly. In addition, replacement can be carried out quickly and easily, resulting in low downtimes.

Preferably, the connection block has the main electronics holder in the form of a connection block electronics holder, whereby the main electronics module is a connection block electronics module. However, it is also conceivable, for example, that an end plate of the hydraulic valve assembly has the main electronics holder with the main electronics module disposed therein.

Preferably, the main electronics module is detachably disposed in the main electronics holder. In particular, it is preferable if the main electronics module can be fixed in the main electronics holder via a positive connection or force fitting connection, for example via a clip connection, latching lugs or a rail connection. It is preferable if the main electronics module has a contact interface that establishes a connection for signal, data and voltage transmission with the main electronics holder when the main electronics module is disposed in the main electronics holder. This can be a plug connection. Of course, it is also conceivable that the contact interface is at least partially configured for wireless signal, data and voltage transmission, for example via an NFC interface. It is preferable if the main electronics holder is disposed in a freely accessible area of the hydraulic valve assembly, in particular in an area facing the environment. In other words, it is preferable if the main electronics module can be inserted into or removed from the main electronics holder directly and without additional assembly or disassembly steps. This makes it easier to replace the main electronics module if necessary.

Preferably, the valve section electronics module is detachably disposed in the valve section electronics holder. In particular, it is preferable if the valve section electronics module can be fixed in the valve section electronics holder via a positive connection or force fitting connection, for example via a clip connection, latching lugs or a rail connection. It is preferable if the valve section electronics holder is disposed in a freely accessible area of the valve section, in particular in an area facing the environment. In other words, it is advantageous if the valve section module can be inserted into or removed from the valve section electronics holder directly and without additional assembly or disassembly steps. This makes it easier to replace the valve section module if necessary.

Preferably, the valve section electronics module has a contact interface that establishes a connection for signal, data and voltage transmission with the valve section electronics holder when the valve section electronics module is disposed in the valve section electronics holder. This can be a plug connection. Of course, it is also conceivable that the contact interface is at least partially configured for wireless signal, data and voltage transmission, for example via an NFC interface. This means that both the main electronics module and the valve section electronics module can be replaced easily, for example in the event of a fault.

Preferably, the main electronics module and the valve section electronics module are different, with the main electronics module having a main control unit. In this context, it is preferable if the valve section electronics module has a secondary control unit. This means that computing-intensive tasks, including computing-intensive tasks of the individual valve section, can be performed by the main control unit, for example control, regulation, device monitoring and predictive maintenance tasks. Less computing-intensive tasks can be performed by the secondary control unit. However, it is also conceivable that all control processes and tasks could be performed by the main control unit. This results in a somewhat more expensive main electronics module, but at the same time a significantly cheaper valve section electronics module. In this case, it is preferable if the main control unit has a main CPU and the secondary control unit has a secondary CPU with significantly less computing power.

Preferably, the hydraulic valve assembly has an electrical backbone, whereby the main electronics module and the valve section electronics module are connected to each other via the electrical backbone. The electrical backbone is the physical interface between the connection block and the valve section. The control and regulation signals are transmitted via this. The electronic backbone is also used to supply power to the valve section. It is therefore particularly preferable if the main electronics module has a backbone communication unit.

For connection to a higher-level unit, it is preferable if the main electronics module has an external communication unit for connection to a bus system, in particular for connection to a fieldbus system. Depending on the configuration of the external communication unit, various fieldbus systems can be connected, for example CAN, Ethernet, FlexRay, LIN or IO-Link.

Preferably, the external communication unit has an interface for wireless communication and/or data transmission. The interface can be, for example, a Bluetooth interface, a WiFi interface, a 5G interface or an NFC interface. The interface can be used to transmit specific information to or receive information from a mobile device or a device that is not connected by cable.

Preferably, the valve section electronics module has a movement control unit. The movement control unit can be a solenoid control unit. The solenoid control unit is configured to apply a current and a voltage into a solenoid, for example a proportional solenoid, of the valve section by means of digital values calculated by the main electronics module and via the backbone communication unit, so that a controlled hydraulic volume flow occurs at the hydraulic consumer. The digital values are calculated in particular via the main control unit. The movement control unit can alternatively be a motor control unit. The motor control unit is configured to control an electric motor or electromechanical drive in such a way that a desired movement is initiated and a controlled hydraulic volume flow occurs at the hydraulic consumer. For this purpose, an electric motor is regularly energized in such a way that a defined rotary movement of a shaft occurs, which is translated into a defined linear movement of an output element via a gearbox.

Preferably, the main electronics module has a voltage connection and a voltage regulator, whereby a supply voltage can preferably be applied to the valve section electronics module via the electrical backbone. The voltage regulator processes the input voltage provided via the voltage connection to such an extent that it is appropriately stabilized, constant and fused as a supply voltage for the internal electronic components of the main electronics module and the valve section electronics module, so that no further processing of the supply voltage for the internal components is necessary. On the other hand, the input voltage is conditioned by the voltage regulator to such an extent that the stability and the current and voltage limits of the electrical energy sufficiently meet the requirements of the solenoid control unit for actuating the at least one solenoid. In addition, the voltage regulator provides protection against overvoltage, polarity reversal and load dump for all supply voltages provided for all downstream users, such as the internal components of the main electronics module and for the valve section electronics module.

Preferably, the valve section has a movable hydraulic closing member, in particular a spool piston. The closing member is moved between at least two positions in a generally known manner, for example to supply hydraulic consumers with the desired pressure or the desired quantity or also to enable relief to the tank. It is therefore preferable for the valve section to have at least one working connection for connecting a hydraulic consumer.

Preferably, a signal-controlled movement of the closing element relieves the working connection. In particular, it is preferable if a signal via the bus system initiates the signal-controlled movement. In this context, it is conceivable that the working connection is equipped with a quick coupling. If a hydraulic consumer is now to be connected to the working connection via the quick coupling, an electronically initiated release is possible. It is not necessary to provide a hand lever or similar for manual relief. Without relief of the working connection, it may be impossible to connect a hydraulic consumer via the quick coupling due to temperature-related volume increases in the hydraulic fluid, for example.

Preferably, the valve section electronics module has a sensor module. Depending on the variant, the sensor module is configured to read out discrete, internal or external sensors. The sensor module is also configured to additionally read sensors with BUS interfaces. The sensors could be pressure sensors, temperature sensors, position sensors, etc., for example. The recorded physical values (temperature, pressure, acceleration, etc.) can be used directly in the secondary control unit or in the valve section electronics module for control optimization, or can be made available to the main control unit or the main electronics module for computationally intensive tasks (e.g. AI control algorithms, condition monitoring, predictive maintenance, etc.).

Preferably, the valve section is a first valve section and the valve section electronics module is a first valve section electronics module. The hydraulic valve assembly preferably has at least one second valve section with a second valve section electronics module, whereby the connection block is hydraulically connected to the first valve section and the second valve section. This makes it possible to use different valve section electronics modules for the first and second valve sections. It may therefore not be necessary to provide a position sensor for the second valve section electronics module if, for example, only supports are controlled via this module.

In this context, it is preferable if the main electronics module is connected to the first valve section electronics module via the electrical backbone. Preferably, the second valve section electronics module has a feed-through for the electronic backbone. The second valve section electronics module is preferably connected to the first valve section electronics module not via the electrical backbone, so that certain regulation, monitoring or control tasks for the second valve section are performed by the first valve section electronics module. It is therefore particularly advantageous if the first valve section electronics module has a secondary control unit and the second valve section electronics module does not have a secondary control unit. This results in a particularly favorable and simply constructed second valve section electronics module.

Preferably, the first valve section has at least one first actuating unit and if the second valve section has at least one second actuating unit, wherein the first actuating unit and the second actuating unit are connected to a movement control unit of the first valve section electronic module. Thus, a movement of the closing member of the first valve section and the closing member of the second valve section can be enabled via a single movement control unit. This reduces the cost of valve section electronic modules.

The first actuating unit can be a first magnet or a first electromechanical drive. The second actuating unit can be a second solenoid or a second electromechanical drive. Depending on the design, the valve sections can therefore be actuated electromagnetically, electromechanically or by an electric motor.

Preferably, the first valve section electronics module has a backbone communication unit. The electrical backbone represents the physical interface between the connection block and the valve section. The control and regulation signals are transmitted via this. The electronic backbone is also used to supply power to the valve section. It is therefore particularly advantageous if the first valve section electronics module has a backbone communication unit.

Preferably, the second valve section has a movable hydraulic closing member, in particular a spool piston. The second valve section electronics module preferably has a second position sensor for monitoring the position of the closing member. The second position sensor is preferably connected to the secondary control unit of the first valve section electronics module. The signal preparation and processing of the second position sensor is not computationally intensive, so that this can be carried out via the secondary control unit of the first valve section electronics module. This means that no secondary control unit is required for the second valve section electronics module, which reduces overall costs.

Although only two valve section electronic modules have been described above, it is also within the scope of the present disclosure that the hydraulic valve assembly comprises three or more valve sections. The valve section electronic modules of the individual valve sections can be configured differently depending on requirements, for example with or without a secondary control unit, with or without a position sensor, etc.

It is also preferable if the valve sections have an identical configuration apart from the respective valve section electronics modules. For example, the function of the respective valve section can be easily adapted by changing the valve section electronics module. It is particularly advantageous if the working connections of the valve sections are equipped with quick-release couplings. This means that basic hydraulic functionality can be maintained even in remote locations if a valve section fails.

In addition, the hydraulic valve assembly according to the present disclosure also allows the valve section electronics modules to be replaced during use as part of a brief interruption. It is only necessary to keep corresponding valve section electronic modules available, for example in the tractor cab. In this context, it is also conceivable that a newly connected valve section electronics module is parameterized via the main electronics module or the main control unit and/or the secondary control unit of another valve section electronics module. In this way, downtimes can be significantly minimized.

FIGS. 1 to 6 show various views of a hydraulic valve assembly 10 according to the present disclosure. The hydraulic valve assembly 10 shown here has a connection block 12 and six valve sections 14.1 to 14.6. The hydraulic valve assembly 10 has a sandwich construction, with the hydraulic supply to the individual valve sections 14.1 to 14.6 being provided via the connection block 12. Consequently, the usual hydraulic elements not shown or described in detail, such as an inlet regulator, a pressure, tank and LS connection, are disposed in and on the connection block 12. In addition, there are corresponding hydraulic supply lines 34 between the connection block 12 and the individual valve sections 14.1 to 14.n, see also FIGS. 8 to 11.

The hydraulic valve assembly 10 also has a main electronics holder 16 with a main electronics module 18 disposed therein. More precisely, the connection block 12 has the main electronics holder in the form of a connection block electronics holder 16. The main electronics module in the form of a connection block electronics module 18 is detachably disposed in the connection block electronics holder 16, for example via corresponding latching elements 32 on a connector plug 30. cf. also FIG. 7. Each of the valve sections 14.1 to 14.6 has a valve section electronics holder 20.1 to 20.6. A valve section electronics module 22.1 to 22.6 is detachably disposed in each valve section electronics holder 20.1 to 20.6, for example via corresponding latching elements 32 on a connector plug 30, see also FIG. 7. Although the valve section electronics modules 22.1 to 22.6 are visually identical and can in principle be accommodated in any of the valve section electronics holders 20.1 to 20.6 via the connecting plug 30, the individual valve section electronics modules 22.1 to 22.6 can differ in their functionality due to different internal electronic components and configuration, as will be explained in more detail below. Here, the connector plug 30 is provided as an example in the form of a USB plug.

Each valve section 14.1 to 14.6 has two working connections 24.5a, 24.5b, 24.6a and 24.6b equipped with quick-release couplings for connecting hydraulic consumers. The working connections 24.5a, 24.5b, 24.6a and 24.6b are fitted with covers.

To relieve the respective working ports 24.5a, 24.5b, 24.6a and 24.6b, each valve section 14.1 to 14.6 has a hand lever 26.1 to 26.6. The hand levers 26.1 to 26.6 are optional, as the pressure can also be relieved electronically, as described in more detail below.

An electrical backbone 28 in the form of a cable harness, shown as an example in FIG. 5, runs protected within the hydraulic valve assembly 10.

With reference to FIGS. 8 to 11, four different variants of a hydraulic valve assembly 10 according to the invention are explained below. The variants differ in principle only in the internal structure of the main electronics module 18 or the valve section electronics modules 22.1 to 22.6.

FIG. 8 shows a first variant of the hydraulic valve assembly 10 according to the invention. In this exemplary embodiment, the main electronics module 18 has a main circuit board 36 with a main control unit 38 disposed thereon. In this example, the main control unit 38 is a main CPU configured for increased computing power. In addition, the main electronics module has a voltage regulator 40, a backbone communication unit 42 and an external communication unit 44.

The voltage regulator 40 processes the input voltage provided via a voltage connection 46 to such an extent that it is appropriately stabilized, constant and fused as a supply voltage for the internal electronic components of the main electronics module 18 and the valve section electronics modules 22.1 to 22.n, so that no further processing of the supply voltage for the internal components is necessary. On the other hand, the input voltage is conditioned by the voltage regulator 40 to such an extent that the stability and the current and voltage limits of the electrical energy sufficiently meet the requirements of movement control unit s 52.1 to 52.n of the valve section electronic modules 22.1 to 22.n for the actuation of actuating units 54.1 to 54.n, as will be described in more detail below. In addition, the voltage regulator 40 provides protection against overvoltage, reverse polarity and load dump for all provided supply voltages for all downstream users, such as the internal components of the main electronics module 18 as well as for the valve section electronics modules 22.1 to 22n.

Depending on whether electromagnetic or electromechanical or electromotive actuation of the valve sections 14.1 to 14.n is envisaged, the movement control units 52.1 to 52.n are configured either as solenoid control units or motor control units. Accordingly, the actuating units 54.1 to 54.n are configured either as proportional solenoids or as electromechanical or electromotive actuators.

The electrical backbone 28 is physically connected via the backbone communication unit 42. The digital data exchange between the main control unit 38 and the individual internal components of the valve section electronic modules 22.1 to 22.n, such as with the solenoid control units 52.1 to 52.n, takes place via the backbone communication unit 42.

The external communication unit 44 is configured for connection to a higher-level unit and for physical connection to a bus system 48, in particular for connection to a field bus system. Depending on the configuration of the external communication unit 44, various field bus systems 48 can be connected, for example CAN, Ethernet, FlexRay, LIN or IO-Link. The control and regulation commands, which are entered by the user via a joystick or an input unit arranged in the cab of the tractor, for example, are transferred via the field bus system 48.

Furthermore, the connection block 12 has an interface for the hydraulic connections 50, in particular a pump connection and a tank connection. The pressure applied via the pump connection is distributed to the individual valve sections 14.1 to 14.n in the conventional manner via the hydraulic supply lines 34. Accordingly, returning hydraulic fluid is discharged to the tank via the hydraulic supply lines 34 and the tank connection.

In this exemplary embodiment, the valve section electronic modules 22.1 to 22.n are all of the same configuration and each have a secondary circuit board 62.1 to 62.n with a movement control unit 52.1 to 52.n and a position sensor 58.1 to 58.n in each case. In the following, the movement control unit s 52.1 to 52.n are described by way of example as solenoid control units, whereby the explanations apply accordingly to a configuration of the movement control unit s 52.1 to 52.n as motor control units.

The individually controllable solenoid control units 52.1 to 52.n impress a current and a voltage into the solenoid arrangement 54.1 to 54.n by means of the digital values calculated by the main control unit 38 and transmitted via the backbone communication unit 42, resulting in a controlled hydraulic volume flow at the corresponding hydraulic working ports 24.1a, 24.1b to 24.na, 24.nb. As shown, each solenoid arrangement 54.1 to 54.n has two respective proportional solenoids which move corresponding closing members 56.1 to 56.n of the individual valve sections 14.1 to 14.n in a conventional and known manner. In this exemplary embodiment, the closing members 56.1 to 56.n are spool pistons.

The position sensors 58.1 to 58.n digitally report the position of the spool piston 56.1 to 56.n of the respective valve section 14.1 to 14.n back to the main control unit 38 via the electrical backbone 28 via the backbone communication unit 42. With the aid of the returned spool position of the position sensors 58.1 to 58.n, the main control unit 38 can calculate new default values for the respective solenoid control units 52.1 to 52.n and thus enable close loop control of the hydraulic volume flow for the hydraulic consumers connected to the hydraulic working ports 24.1a, 24.1b to 24.na, 24.nb.

Furthermore, the external communication unit 44 can also have an interface for wireless communication, for example a Bluetooth interface or an NFC interface. This allows data to be transmitted to or from a mobile device, for example.

FIG. 9 shows a second variant of a hydraulic valve assembly 10 according to the invention. The second variant differs from the first variant shown in FIG. 8 in the configuration of the valve section electronic modules 22.1 to 22.n.

In this exemplary embodiment, the first valve section electronics module 22.1 and the third valve section electronics module 22.3 each have only one feed-through 60.1 and 60.3 for the electrical backbone 28 and a position sensor 58.1 and 58.3. The second valve section electronics module 22.2 has a secondary control unit 64.2 disposed on the secondary circuit board 62.2, a solenoid control unit 52.2, a position sensor 58.2 and a backbone communication unit 66.2.

The position sensors 58.1 and 58.3 of the first valve section electronic module 22.1 and the third valve section electronic module 22.3 are connected to the secondary control unit 64.2 of the second valve section electronic module 22.2 via a connection 68, which may also be part of the electrical backbone 28. Similarly, the solenoid arrangements 54.1 and 54.3 of the first valve section 14.1 and the third valve section 14.3 are connected to the solenoid control unit 52.2 of the second valve section electronics module 22.2 via a connection 70, which may also be part of the electrical backbone 28. The digital data exchange between the secondary control unit 64.2 and the main control unit 38 takes place via the backbone communication unit 66.2 of the second valve section electronics module 22.2. The secondary control unit 64.2 is configured for less computationally intensive tasks compared to the main control unit 38.

The position sensors 58.1 to 58.3 directly connected here report the spool position of the respective valve section 14.1 to 14.3 digitally via the electrical backbone 28 via the backbone communication units 42, 52.2 to the main control unit 38 by means of the secondary control unit 64.2. With the aid of the spool position reported back, the main control unit can calculate new default values for the second valve section electronics module 22.2 and thus enable close loop control of the hydraulic volume flow for the hydraulic consumers connected to the hydraulic working connections 24.1a, 24.1b to 24.3a, 24.3b by transferring the default values to the secondary control unit 64.2 accordingly.

FIG. 10 shows a third variant of a hydraulic valve assembly 10 according to the invention. The third variant differs from the first and second variants in that all valve section electronics modules 22.1 to 22.n are essentially constructed in the same way as the second valve section electronics module 22.2 in the second variant shown in FIG. 9. In addition, all valve section electronics modules 22.1 to 22.n also have a sensor module 72.1 to 72.n. Depending on the variant, each sensor module 72.1 to 72.n is configured to read discrete, internal or external sensors. Each sensor module 72.1 to 72.n is also configured to additionally read sensors with BUS interfaces. The sensors could be pressure sensors, temperature sensors, position sensors, etc., for example. The recorded physical values (temperature, pressure, acceleration, etc.) can be used directly in the secondary control unit 64.1 to 64.n or in the valve section electronics module 22.1 to 22.n for control optimization, or can be made available to the main control unit 38 or the main electronics module 18 for computationally intensive tasks (e.g. AI control algorithms, condition monitoring, predictive maintenance, etc.).

In addition, the main electronics module 18 also has a sensor module 74. The sensor module 74 is also configured to read out the discrete, internal or external sensors. The sensor module 74 is also configured to additionally read out sensors with BUS interfaces. The sensors could, for example, be pressure sensors, temperature sensors, position sensors, etc. The recorded physical values (temperature, pressure, acceleration, etc.) can be used directly in the main control unit 38 for control optimization or other tasks (e.g. AI control algorithms, condition monitoring, predictive maintenance, etc.).

FIG. 11 shows a fourth variant of a hydraulic valve assembly 10 according to the invention. The fourth variant differs from the variants shown in FIGS. 8 to 10 in that the first valve section electronics module 22.1 is configured like the first valve section electronics module 22.1 of the variant shown in FIG. 10, in that the second valve section electronics module 22.2 is configured like the second valve section electronics module 22.2 of the variant shown in FIG. 9, that the third valve section electronics module 22.3 is configured like the third valve section electronics module 22.3 of the variant shown in FIG. 9, and that the fourth valve section electronics module 22.4 is configured like one of the valve section electronics modules 22.1 to 22.n of the variant shown in FIG. 8. The main electronics module 18 corresponds to the main electronics module 18 shown in FIG. 10.

Furthermore, in all four variants shown in FIGS. 8 to 11, the hydraulic working connections 24.1a, 24.1b to 24.na, 24nb can be relieved without a hand lever. For this purpose, the user initiates a signal via the field bus system 50, e.g. on an input device. The main control unit 38 generates a control sequence, which then causes a certain movement of the spool pistons via the electrical backbone 28 and the other components on the solenoid arrangements 54.1 to 54.n and relieves the hydraulic working connections 24.1a, 24.1b to 24.na, 24nb to the tank.

It should be noted that the terms “first”, “second”, “third”, etc. used in this disclosure do not define a desired order, but merely serve to conceptually distinguish the individual elements. Thus, for example, it is also part of this disclosure that there is a “second” element without a “first” element.

1-27. (canceled)

28. A hydraulic valve assembly, comprising:
a connection block;
at least one valve section hydraulically connected to the connection block; and
a main electronics holder with a main electronics module disposed therein,
wherein the valve section comprises a valve section electronics holder with a valve section electronics module disposed therein.

29. The hydraulic valve assembly according to claim 28, wherein the connection block comprises the main electronics holder in the form of a connection block electronics holder, and wherein the main electronics module is a connection block electronics module.

30. The hydraulic valve assembly according to claim 28, wherein the main electronics module is detachably disposed in the main electronics holder.

31. The hydraulic valve assembly according to claim 28, wherein the valve section electronics module is detachably disposed in the valve section electronics holder.

32. The hydraulic valve assembly according to claim 28, wherein the main electronics module and the valve section electronics module are different, the main electronics module comprising a main control unit.

33. The hydraulic valve assembly according to claim 32, wherein the valve section electronics module comprising a secondary control unit.

34. The hydraulic valve assembly according to claim 28, wherein the hydraulic valve assembly comprises an electrical backbone, the main electronics module and the valve section electronics module being connected to one another via the electrical backbone.

35. The hydraulic valve assembly according to claim 34, wherein the main electronics module comprises a backbone communication unit.

36. The hydraulic valve assembly according to claim 28, wherein the main electronics module comprises an external communication unit for connection to a bus system.

37. The hydraulic valve assembly according to claim 36, wherein the external communication unit comprises an interface for wireless communication or data transmission.

38. The hydraulic valve assembly according to claim 28, wherein the valve section electronics module comprises a movement control unit.

39. The hydraulic valve assembly according to claim 28, wherein the main electronics module comprises a voltage connection and a voltage regulator, wherein a supply voltage can be applied to the valve section electronics module via an electrical backbone.

40. The hydraulic valve assembly according to claim 28, wherein the valve section comprises a movable hydraulic closing member.

41. The hydraulic valve assembly according to claim 40, wherein the valve section electronics module comprises a position sensor for monitoring a position of the closing member.

42. The hydraulic valve assembly according to claim 28, wherein the valve section comprises at least one working connection for connecting a hydraulic consumer.

43. The hydraulic valve assembly according to claim 42, wherein a signal-controlled movement of the closing member relieves the working connection.

44. The hydraulic valve assembly according to claim 43, wherein a signal via a bus system initiates the signal-controlled movement.

45. The hydraulic valve assembly according to claim 28, wherein the valve section electronics module comprises a sensor module.

46. The hydraulic valve assembly according to claim 28, wherein the valve section is a first valve section and the valve section electronics module is a first valve section electronics module, and
the hydraulic valve assembly comprises at least one second valve section with a second valve section electronics module, wherein the connection block is hydraulically connected to the first valve section and the second valve section.

47. The hydraulic valve assembly according to claim 46, wherein the main electronics module is connected to the first valve section electronics module via an electrical backbone.

48. The hydraulic valve assembly according to claim 47, wherein the second valve section electronics module has a feed-through for the electrical backbone.

49. The hydraulic valve assembly according to claim 48, wherein the second valve section electronics module is connected to the first valve section electronics module.

50. The hydraulic valve assembly according to claim 49, wherein the first valve section electronics module comprises a secondary control unit and wherein the second valve section electronics module does not comprise a secondary control unit.

51. The hydraulic valve assembly according to claim 46, wherein the first valve section comprises at least one first actuating unit and wherein the second valve section comprises at least one second actuating unit, wherein the first actuating unit and the second actuating unit are connected to a movement control unit of the first valve section electronics module, wherein the first actuating unit is preferably a first solenoid or a first electromechanical drive, and wherein the second actuating unit is preferably a second solenoid or a second electromechanical drive.

52. The hydraulic valve assembly according to claim 46, wherein the first valve section electronics module comprises a backbone communication unit.

53. The hydraulic valve assembly according to claim 46, wherein the second valve section comprises a movable hydraulic closing member, in particular a spool piston, wherein the second valve section electronics module comprises a second position sensor for monitoring a position of the closing member.

54. The hydraulic valve assembly according to claim 52, wherein the second position sensor is connected to a secondary control unit of the first valve section electronics module.
